(19) United States
(12) Patent Application Publication
(10) Pub. No.: US 2010/0003381 A1
(43) Pub. Date: Jan. 7, 2010

(54) MOBILE CONCENTRATION SYSTEM AND METHOD FOR MILK

(75) Inventor: Andrew Smith, Auckland (NZ)

Correspondence Address: BROOKS KUSHMAN P.C., 1000 TOWN CENTER, TWENTY-SECOND FLOOR, SOUTHFIELD, MI, 48075, US

(73) Assignee: PACIFIC PROCESS LIMITED, Remuera, Auckland (NZ)

(21) Appl. No.: 12/523,816

(22) PCT Filed: Jan. 17, 2008
(86) PCT No.: PCT/NZ08/00003

§ 371 Date: Jul. 20, 2009

(30) Foreign Application Priority Data
Jan. 18, 2007 (NZ) 552681

(51) Int. Cl. A23C 1/00; B01D 61/08

(52) U.S. Cl. 426/231; 210/136

(57) ABSTRACT

A mobile concentration system (MCS) for milk comprising: a vehicle having a holding tank for receiving and holding milk; and a concentration system mounted to the vehicle and coupled in fluid communication with the holding tank. The concentration system adapted to remove milk from the holding tank and process the milk while the vehicle is stationary and/or uploading or unloading of milk, or underway. The concentration system including a reverse osmosis filtration system adapted receive the milk from the holding tank and process the milk to generate a stream of substantially water and a product stream of concentrated milk. A feed section comprises product/water/CIP (clean in place) valving systems, high pressure pumping equipment operating to receive and pressurize the milk through-out the system. A concentration level control system includes a control valve regulating the concentrate flow to achieve a fixed system operating pressure to control the system. A method of collecting and concentrating milk from the concentration system comprising: under pressure, depositing milk into a holding tank; drawing milk from the holding tank while the vehicle is stationary and/or uploading or unloading of milk, or underway and directing the milk to the concentration system carried by the vehicle; and operating the concentration system while the vehicle is stationary and/or uploading or unloading of milk, or underway to remove water from the milk by reverse osmosis filtration system in combination with the concentration level control system.

The invention relates generally to a mobile concentration system and method for milk (MCS), and more specifically to a mobile milk concentration system and methods for concentrating milk while stationary and/or uploading or unloading of milk, or underway.

### BACKGROUND OF THE INVENTION

In the dairy industry, a liquid food product such as raw milk as collected and received from a cow/farm and processed/concentrated to remove water or permeate at a land based plant by RO filtering. The land based plant has a feed section and filter section to receive the raw milk to form two main end products of milk concentrate and water. The fixed plant can also be called a ‘membrane plant’, a ‘filtration system’ or ‘concentrating factory/plant’. The term ‘membrane’ is in reference to a type of filtering as generally used for any liquid food products. Therefore terminology associated filtration plant designs is varied with many terms able to be applied to single components that make up a membrane plant, and its operations. This specification may refer to the various components by any of the terms as listed below. Descriptions of components are as follows:

MCS Feed section: MCS Feed Module, MSC Feed pumping system.
MCS Milk Concentrate: retentate
MCS Water: Permeate, cow water, filtrate.
RO: reverse osmosis filtration process
Complete MCS: Filter Truck/vehicle, membrane truck/vehicle, RO Truck/vehicle, RO Plant, filtering system or concentrating plant.

In the dairy industry, the high costs associated with the transport of raw milk significantly reduce profit margins. One solution has been to ship the raw milk to a stationary concentrating plant, wherein as much water as possible is removed from the milk to reduce its volume. The concentrated milk is then shipped to various locations for either reconstituting or processing to form other dairy products, such as cheese. By reducing the volume of milk to be shipped, the concentrating plant provides a way to reduce some of the costs associated with transporting milk down stream of the concentrating plant.

Although effective, such concentrating plants are not without their problems. For instance, the raw milk, in a non-concentrated state, must still be transported from the farm to the concentrating plant. Thus, transporting costs are still high. Further still, the concentrating plant may be located in an area that is far from the farm where the milk is produced. Installation costs for a remote land based milk concentrating plant is high, due to the added cost of the infrastructure needed to support the milk concentration plants operations, such as; product storage tanks, load in & out, services and civil works (buildings and roading etc), cleaning systems and electricity. Also, transporting the milk to the milk concentration plant may not be cost effective due to the distance between the dairy farm and the milk concentration plant. Further, the milk must be unloaded, processed, and reloaded, increasing transport costs. Therefore, there exists a need for a system or method which can further reduce the cost of transporting milk in the dairy industry.

Membrane filtration plants have been utilized in the global diary industry for 40+ years, and ‘spiral wound’ membrane design was introduced many years ago and quickly became the standard design in use. It should be noted that to date the use of this technology for the mobile concentration of farm milk as described in this patent application has not been considered, or pursued in any way in all of the 40 years this technology has been in use. It needs also to be noted that the New Zealand Dairy Industry is recognised as a world leader in the development of dairy processing technology and has been at the forefront of many processes now commonplace within the global dairy industry.

The process of the Reverse Osmosis (RO) of raw milk has been used since the 1960's both at the processing plant, but more commonly then, at the farm. For example Alfa Laval patented a process in 1969.

Membrane filtration plants or concentrating factories, while being a staple of the dairy process, are not without their problems. These plants or factories are notoriously difficult to clean (required daily), risky to operate (membrane damage can easily occur through excess pressure, temperature and chemical exposure), they traditionally have high power requirements to operate, are technically demanding and are physically large. The membranes are expensive should they be damaged (and they can be easily).

On why this has not been done before; anyone considering the application of Reverse Osmosis (RO) onto a mobile vehicle, and that the RO would be need to operate while the vehicle was in motion, until recently would have discounted the idea as the plants were too big, too complicated, too difficult to clean and too risky to operate.

The present invention is the result of 15 years membrane plant construction experience by the inventor that has made it possible to address the problems identified, and produced a design that is compact, lightweight, has a low power requirement, can be technically basic, low risk to membranes and can be cleaned easily.

Another problem with existing fixed plant membranes is the need to be protected against damage due to pressure, temperature and chemical exposure limits being exceeded. This is done with a comprehensive range of expensive and complicated instrumentation.

Factory based membrane plants have a wide range of instrumentation fitted and automated computer control systems which allow the plant to operate in many ways, for example in either constant flux where the plants operating pressure fluctuates but flow profiles and flux rate are unchanged, or constant pressure where the plants flow rate is allowed to deteriorate as the plant fouls. Current systems utilise a combination of feed and retentate flow meters, and some form of solids measurement (refractometers/turbidity meters) and ratio set points (known as VCF) to control the plants.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT OF THE INVENTION

It is an object of the invention to provide a mobile concentration system and method for milk that ameliorates some of the disadvantages and limitations of the known art or at least provides the public with a useful choice.

### SUMMARY OF THE INVENTION

In a first aspect the invention resides in a mobile concentration system MCS 100 for milk comprising:
(a) a vehicle having a tank for receiving and holding milk 116; and
(b) a concentration system 100 mounted to the vehicle and coupled in fluid communication with the holding tank 116, the concentration system 100 adapted to remove milk from the holding tank and process the milk while the vehicle is stationary and/or uploading or unloading of milk, or underway, the concentration system including a reverse osmosis filtration system 106 adapted receive the milk from the holding tank 116 and process the milk to generate a stream of substantially water 132 and a product stream of concentrated milk 110,
(c) the concentration system including:
   (i) Feed section comprising product/water/CIP (clean in place) valving systems, high pressure pumping equipment (one or more pumps) 124 operating to receive and pressurize the milk through-out the system.
   (ii) Concentration level control system comprising a control valve regulating the concentrate flow 110 to achieve a fixed system operating pressure to control the system.

Preferably the MCS includes conductivity monitoring of the system permeate to determine when target milk solids are achieved.

Preferably the filtration system 106 includes a filter module comprising membranes 128, pressure vessels 106, recirculation pumping equipment 126 and permeate collection tank 134 operating as described in 1b.

Preferably the water or permeate can be stored in storage systems 134, 136 or can be discharged 138.

Preferably the milk concentration receiving tank 118 can be a separate movable storage tank.

In another aspect the invention resides in a method of collecting and concentrating milk from the mobile concentration system (MCS) as previously disclosed, the method comprising:
(a) utilizing the feed section and depositing milk into a holding tank of a vehicle;
(b) drawing milk from the holding tank while the vehicle is stationary and/or uploading or unloading of milk, or underway and directing the milk to a milk concentration system carried by the vehicle; and
(c) operating the milk concentration system while the vehicle is stationary and/or uploading or unloading of milk, or underway to remove water from the milk by reverse osmosis filtration system in combination with the concentration level control system whereby the fixed system is operating under pressure to separately produce concentrated milk and water.
(d) delivering the concentrated milk to the processing plant, or transferring the concentrated milk to ‘bulk haul’ tankers who deliver the concentrated milk to a milk concentration processing plant.

In another aspect the invention resides in a method of operating the mobile concentration system (MCS) to form milk concentrate and waste water as previously claimed in a small scale batch style operation suitable for farms being far apart enough to allow for the concentrating of the milk at a lower collection rate. For this design, the MCS includes a single feed system 104 and single filter system 106 coupled to a vehicle holding tank 116 and simultaneously extracts water, and deposits the milk concentrate in the same holding tank 116 until target solids are achieved, and the holding tanks are full. The milk concentrate is normally delivered directly to a milk processing factory. It is unlikely the concentrate would be transferred to a factory bulk haul vehicle.

In another aspect the invention resides in a method of operating the mobile concentration system (MCS) as previously claimed to form milk concentrate and waste water, in a medium size single pass operation, the system comprises a vehicle, at least one feed section module 124, and two or more filter modules 106, whereby this system design is intended to travel a milk collection route, picking up and concentrating milk continuously for many hours, the system has a farm milk holding tank 116, MCS, water/permeate holding tank 134 and produces full strength concentrate continuously which is stored in a vehicle trailer unit 118 so that bulk haul vehicle from a processing factory to collect the milk concentrate from the system vehicle and transfers it to the factory. This design continues to travel the collection route, concentrating the milk, transferring the concentrate to ‘bulk haul vehicles’ which transfer it to the processing factory.

In another aspect the invention resides in a method of operating the mobile concentration system (MCS) as previously claimed to produce milk concentrate and waste water, in a large scale single pass operation, the system comprises at least one vehicle, two or more feed systems 104, and two or more filter systems 106, this vehicle design is substantially all RO (membrane) plant with a small feed holding tank 116, whereby this design is intended to travel to a stationary area along a milk collection route, other vehicles collect the milk and deliver it to a stationary vehicle where it is processed and stored in vehicle trailer units 118 brought to the site so that the system has a small feed tank 116, MCS 104, permeate holding tank 134 and produces full strength concentrate continuously which is stored in the vehicle trailer units 118 brought to the site, bulk haul vehicles from a processing factory collect the milk concentrate from the vehicle storage trailers and transfer it to the factory and the mobile milk concentration system will still return to the factory at periodic intervals for cleaning.

### BRIEF DESCRIPTION OF THE DRAWINGS

The invention will now be described, by way of example only, by reference to the accompanying drawings:

FIG. 1 is a schematic diagram of one embodiment of a mobile concentration system formed in accordance with a first preferred embodiment of the invention; This diagram demonstrates the general filtration plant process with the Mobile Concentration System MCS ‘RO plant’ and truck tanks in fluid connection, the MCS RO plant powered by on vehicle/truck power sources, and the system either running in batch or continuous concentration mode.

FIG. 2 is an elevation view of the mobile milk concentration system of FIG. 1;

FIG. 3 is a schematic drawing of an alternate embodiment of a mobile concentration system formed in accordance with the present invention showing a single loop system, which may be used with or without a circulating pump. This design utilizes what is known as a ‘batch’ mode of operation where the MCS RO plant is in fluid connection with the milk tank and recirculates the milk between the tank and the plant. The milk in the tank is steadily concentrated to the required set point solids level.

FIG. 4 is a schematic drawing of an alternate embodiment of a mobile concentration system formed in accordance with the present invention showing a multiple loop, continuous retentate concentration system (known as a multi-stage system); this multistage design produces target specification concentrate continuously, which allows for fully concentrated product to be continuously collected by the trailer unit.

FIG. 5 is a schematic drawing of an alternate embodiment of a mobile concentration system formed in accordance with the present invention showing a multiple loop, continuous permeate concentration system with permeate feed boost (also known as a multi-stage system); The ‘retentate’ can be the waste stream in this particular design, as the permeate is re-pumped to MCS RO operating pressures and filtered yet again to improve the water purity.

FIG. 6 is a schematic drawing of an alternate embodiment of a mobile concentration system MCS formed in accordance with the present invention showing a multiple loop, continuous permeate concentration, array design system that may be configured with or without a boost pump. Not a design commonly used for milk concentrating, this design operates in ‘batch’ style fluid connection to the milk tank.

FIG. 7 is a drawing of a four vessel filter pack suitable for use with the present invention;

FIG. 8 is a drawing of a two vessel filter pack suitable for use with the present invention;

FIG. 9 is a drawing of an eight vessel filter pack suitable for use with the present invention;

FIG. 10 is a drawing showing a MCS milk transport vehicle fitted with a side mounted filter pack;

FIG. 11 is a drawing showing an alternate embodiment of a mobile concentration system MCS;

FIG. 12 is a drawing showing yet another alternate embodiment of a mobile concentration system MCS; and

FIG. 13 is a drawing showing yet another alternate embodiment of a mobile concentration system MCS; the mobile ‘multistage’ system (still collects milk)

FIG. 14 is a drawing showing yet another alternate embodiment of a mobile concentration system MCS; the mobile ‘multistage’ system (still collects milk)

FIG. 15 is a drawing showing yet another alternate embodiment of a mobile concentration system MCS; the stationary ‘multistage’ system (milk is brought to the truck for processing).

FIGS. 16 to 20 are drawings showing other embodiments of the invention.

FIG. 21 is a drawing showing a design for the modular components that make up the ‘modular’ design concept of the MCS.

FIG. 22 is a drawing showing the differentiation between three types of modular system designs for the feeding and filtration modules.

### DETAILED DESCRIPTION OF THE PREFERRED EMBODIMENT

The following description will describe the invention in relation to preferred embodiments of the invention, namely a mobile concentration system (MCS) and methods. The invention is in no way limited to these preferred embodiments as they are purely to exemplify the invention only and it is noted that possible variations and modifications would be readily apparent without departing from the scope of the invention.

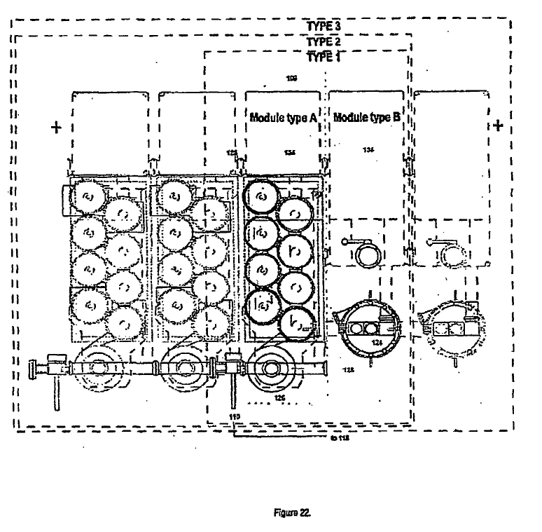

There are several ways or methods of use for this concept of mobile collection such as for example: Type 1—Single Stage ‘Batch’ style operation (also see FIG. 22) where the mobile concentration system continuously recirculates milk while in fluid connection to the milk tank. The milk is progressively concentrated as the plant continues to operate. This system is suited to catchment areas where the farms are spaced such that the plant has time to ‘keep up’ with the uploading rate of the collection route. The system comprises (as a minimum) of a single feed section 124 and a single filter section 106. The system is coupled to the truck tank 116, and simultaneously extracts milk, and deposits concentrate in the same tank 116. This method can be used where the farms are far apart and the system has time to process the milk at the lower collection rate. This type would normally deliver its own concentrate to the processing plant (i.e., the concentrate would not be transferred to a factory bulk haul tanker).
Other method examples are disclosed on page 31 in regard to larger scale plants as shown in FIG. 22 as labelled as Type 2 and type 3.

For the purposes of this patent document, Type 1 has been used to describe the functionality of the Mobile Concentration System (MCS) as follows.

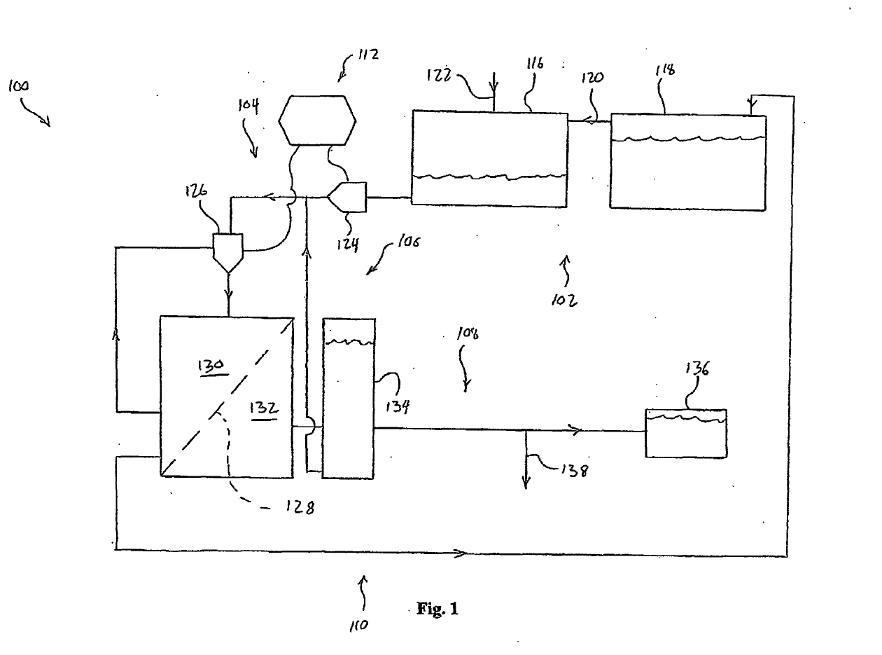

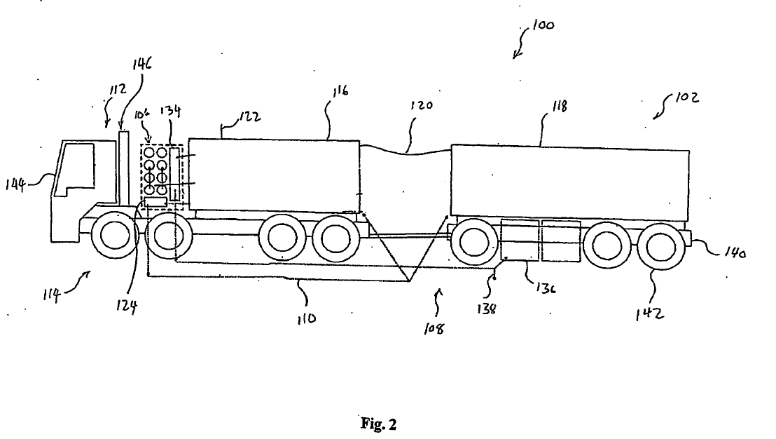

FIGS. 1 and 2 show one embodiment of a mobile milk concentration system 100 formed in accordance with the present invention. Generally described, the milk concentration system 100 provides a way of reducing the volume of milk (or raw milk as collected from a farm) carried by a milk transport vehicle while the milk transport vehicle is underway by removing water/permeate from the milk. More specifically, the mobile milk concentration system MCS 100 permits the removal of water and concentration of the raw milk obtained at a first load point or source, such as a dairy farm, as the vehicle travels to a second load point or source, thereby permitting a single vehicle to receive a volume of raw milk greater than its storage capacity as the truck makes it rounds, greatly increasing its efficiently and profitability.

The mobile concentration system 100 includes a milk storage system 102, a pump system 104, a filtration system 106, an effluent system 108, a concentrate system 110, a power system 112, and a drive train 114. The milk storage system 102 includes one or more storage tanks 116 and 118 for storing milk. In the illustrated embodiment, two storage tanks 116 and 118 are illustrated and described. The storage tanks 116 and 118 are preferably in fluid communication with one another by an overflow line 120, such that when one of the storage tanks 118 is full or nearly so with milk concentrate, the contents of the storage tank 118 begin to flow to the other tank 116. At least one of the tanks includes a milk inlet connection 122 permitting the tank 116 to be filled with raw milk. The storage tanks 116 and 118 are preferably fully compliant with all regulations regarding the storage of edible products such as milk, and preferably are of a size that approaches or equals the maximum allowable to be carried by the vehicle which will carry the tanks.

The feed system 104 includes a pump system which may include a main feed pump 124 and a circulation pump 126. The main feed pump 124 is preferably coupled to the storage tanks 116 and 118 and is operable to draw milk from one or both of the storage tanks 116 and 118 and pressurize same to a predetermined filtration pressure. Preferably, the predetermined filtration pressure falls between a minimum pressure of about 10 or 15 bars and a maximum pressure of about 25, 30, or 40 bars, with a most preferred pressure of about 20 bars. Preferably, the main feed pump 124 is operable to pump the milk at a predetermined flow rate. Preferably, the predetermined flow rate falls between a minimum flow rate of about 2, 5, 10, 15, 20, or 25 m³/hr and a maximum flow rate of about 30, 35, 40, 45, or 50 m³/hr, with a most preferred flow rate of about 30 m³/hr.

The circulation pump 126 is operable to circulate the milk, once pressurized by the main feed pump 124, through the filtration system 106. The filtration system 106 is adapted to filter an influent stream to separate out the water contained in the influent stream from the milk solids. The filtration system 106 of the illustrated embodiment is of a reverse osmosis type filtration system, however it is noted that other types of filtration systems are within the spirit and scope of the present invention, a few suitable examples being nanofiltration, ultrafiltration, and microfiltration systems.

The filtration system 106 includes a filtration barrier 128 which permits only water to pass therethrough. The filtration barrier 128 thus divides the filtration system 106 into a concentrate side 130 and a water or effluent side 132. The milk solids are trapped on the concentrate side 130, while water is forced through the filtration barrier 128 to the water side 132. The filtration system 106 may be of any suitable design for separating out the water from the milk, a few suitable examples being a single stage system, or a multi-stage system with varying system pumping designs and requirements.

The effluent side 132 of the filtration system 106 is coupled to a flush water collection tank 134. The flush water collection tank 134 is adapted to store a predetermined quantity of the removed water and store same for use in flushing the concentrate side 130 of the filtration system 106 when the system is shut down, as will be described in greater detail below. The flush water collection tank 134 may hold between 100 and 5000 litres, and more preferably between 300 and 400 litres. The filtration system 106 preferably holds between 100 and 400 litres, and more preferably between 200 and 300 litres.

The effluent system 108 includes an effluent (water) storage tank 136 and a discharge outlet 138. The effluent storage tank 136 is adapted to store a predetermined quantity of effluent for later discharge at a suitable location, such as to a sewer, treatment facility, dairy farm irrigation system, etc. The discharge outlet 138 permits the immediate discharge of the effluent to a suitable location, such as the road or ditch while the vehicle is moving or stationary. The effluent system 108 also includes the pumps, piping, and valves to control the flow of effluent.

The concentrate system 110 places the concentrate side 130 of the filtration system 106 in fluid communication with at least one of the storage tanks 116 and 118. Moreover, the concentrate system 110 includes piping, pumps, and valves for delivering the concentrated milk back to the storage tanks 116 and 118.

The power system 112 is adapted to power all of the pumps and controls of the mobile milk concentration system 100. The power system 112 is preferably portable, and adapted to be carried upon the milk transport vehicle. Most preferably, the power system 112 simply draws off or is an extension of the milk transport vehicle's own electric, hydraulic, or mechanical power system. Alternately, the power system 112 is a stand alone system carried by the milk transport vehicle and operable to generate its own power source for powering the mobile milk concentration system 100. Preferably the power system 112 requires less than 150 kw/hr, or even less, such as less than 50 kw/hr.

Turning to FIG. 2, the drive train system 114 may include the normal components associate with a milk transport vehicle, including a frame 140 for supporting other components of the mobile milk concentration system 100, a plurality of wheels 142 for permitting the mobile milk concentration system 100 to be easily moved over a surface, a cab 144 for housing a driver, and an engine 146 for driving one or more of the wheels 142. As stated above, the engine 146 preferably provides the power to operate the mobile milk concentration system 100, such that the mobile milk concentration system 100 does not require connection to a stationary source, and therefore is fully mobile and operable to process the milk while the milk transport vehicle is underway.

Differing construction combinations of feed and filter functions can be formed as modules which can be assembled to meet the specific production capacities required of the varying production areas and catchment sizes. Refer FIG. 22 which demonstrates the two module types.

Module Type A: Filter modules: These modules contain the filter membranes 128, loop recirculation pump 126 and permeate collection tank 134. Many filter modules 106 can be connected in series according to the production capacity required. Each module addition increases the plants active membrane filter area.

Module Type B: Feed section module: These modules contain the feed section high pressure pumping equipment 124, milk/water/CIP supply valves and pre-filters 124, the permeate collection tank 134 (coupled to the filter module permeate collection tanks 134), the hydraulic power equipment and control systems for the plant operations. Again to increase system capacity, additional feed modules can be connected in series to achieve this.

In light of the above description of the components of the mobile milk concentration system 100, the operation of the mobile milk concentration system 100 will now be described. Still referring to FIGS. 1 and 2, the milk transport begins operation by driving to a first location wherein raw milk is received in the forward storage tank 116 via inlet 122. The feed pump 124 is operated to pressurize the raw milk. The circulation pump 126 recirculates the raw milk through the filtration system 106, wherein through a reverse osmosis process, the water begins to be separated from the solids contained in the raw milk. The water is directed into the flush water storage tank until that tank is full or nearly full. The concentrated milk, which has had its milk solids content increased from a raw milk level content to a predetermined concentrated solids content, one example being from 13% milk solids content to 25% milk solids content, is directed and discharged into the rear tank 118.

Once the flush water storage tank 134 is full, any further water is directed to either the storage tank 136 for later discharge or through outlet 138 for immediate discharge. The system continues to operate while the milk transport vehicle travels from the first pick up point to the second, clearing space in the tanks to receive additional raw milk. As the vehicle travels, raw milk is continuously drawn from the forward tank 116 and separated, with the water being discharged or stored, and the concentrated milk directed to the rear storage tank 118. Thus, the level of raw milk in the forward tank 116 decreases and the level of concentrated milk in the rear tank 118 increases.

At each pick up point (dairy farm), the raw milk is loaded into the forward tank 116 and subsequently processed. When the level in the rear tank 118 reaches a predetermined level, i.e. it is filled or nearly filled, the concentrated milk spills back into the forward tank 116. Although this decreases the efficiency of the system as concentrated milk is then mixed with the raw milk stored in the forward tank 116, the milk transport vehicle is nearing completion of its rounds and this decrease of efficiency is acceptable. The milk transport vehicle continues picking up raw milk until either both tanks 116 and 118 are full or the driver's designated route is completed. The milk transport vehicle then heads to a processing plant for processing of the milk carried in the tanks 116 and 118. As the milk transport vehicle heads to the processing plant, the mobile milk concentration system 100 can be either shut down, or run to further reduce the water content of the milk. Upon shut down of the system, the water present in the flush water storage tank 134 is directed into the concentrate side 130 of the filtration system 106 to push the concentrated milk held therein into the storage tanks 116 and 118. The filtration system 106 is then cleaned by any number of well known methods. It is noted that although a two tank 116 and 118 system is illustrated and described, alternately, a single tank may be used with the concentrated milk returned to the same tank in which raw milk is collected in and in which milk is drawn off of for separation.

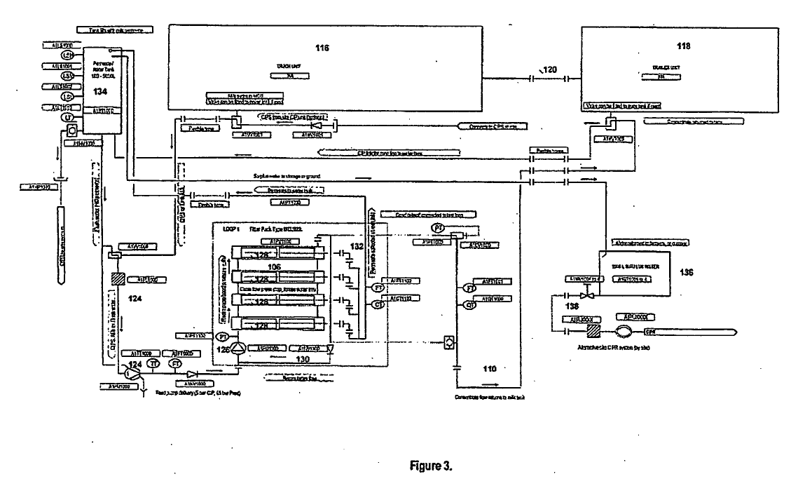

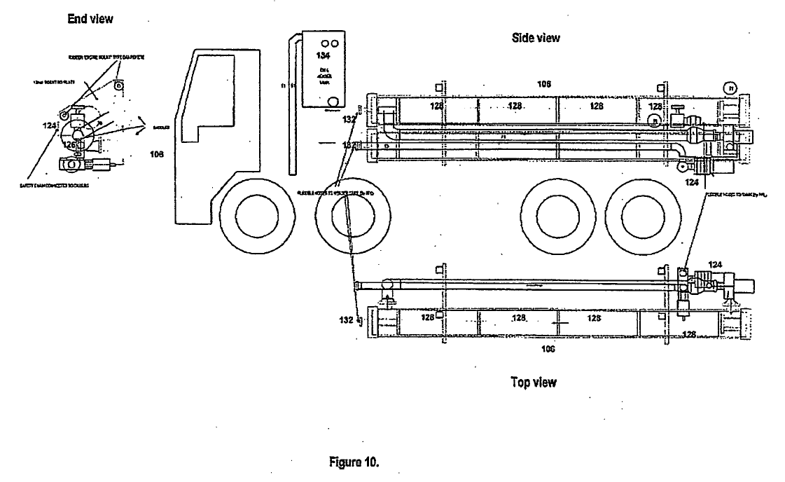

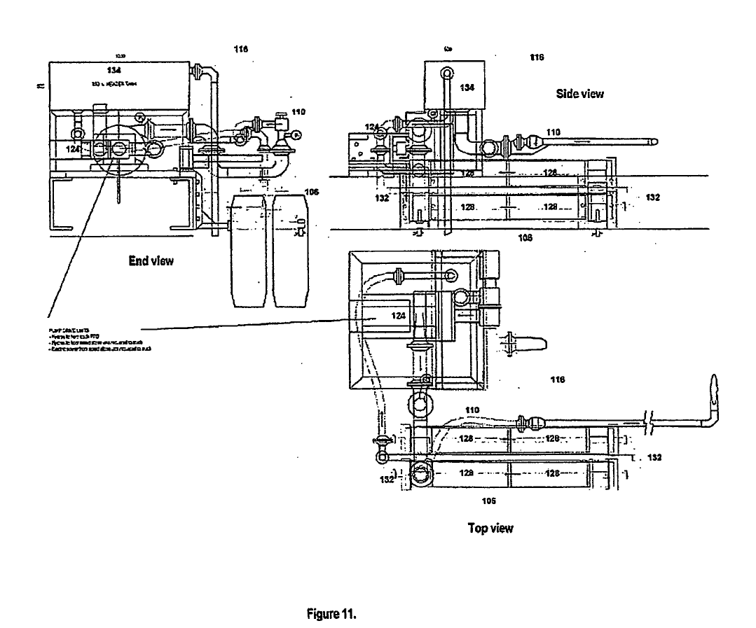

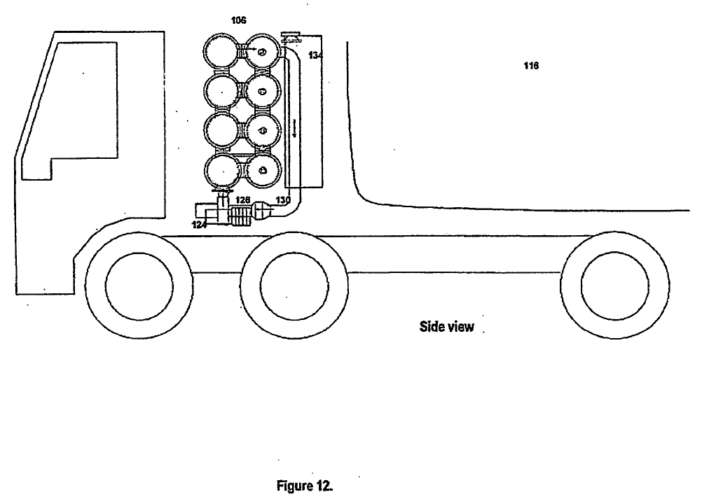

Referring to FIGS. 3-12, alternate embodiments of the mobile milk concentration system formed in accordance with the present invention are illustrated and described. Generally described, the mobile milk concentration systems are adapted to be mounted to (i.e. include) a milk tanker truck and use Reverse Osmosis (RO) filtration technology to remove water from the milk being collected by the milk tanker.

The mobile milk concentration system is a fully mobile and removable machine that can either be retro fitted to existing milk tankers, or built into new tankers under construction. Differing filter pack designs can be utilised to allow the system to be fitted to any part of the truck (on the side, front or end of the tank), and in fact can be fitted to the trailer unit or truck unit.

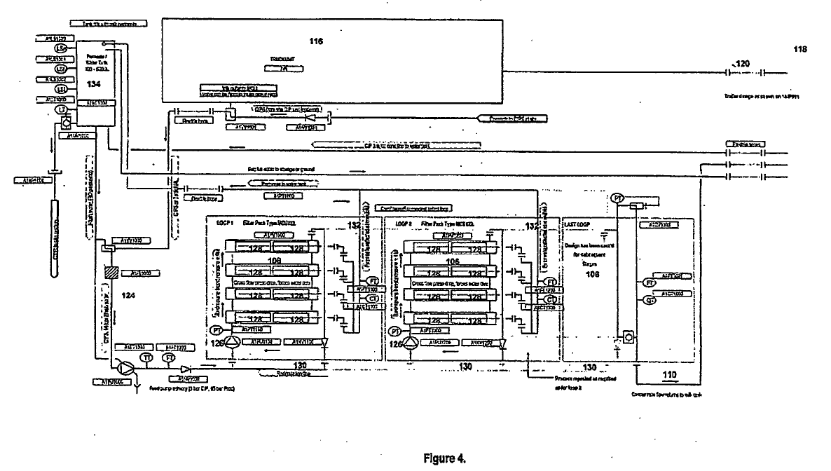

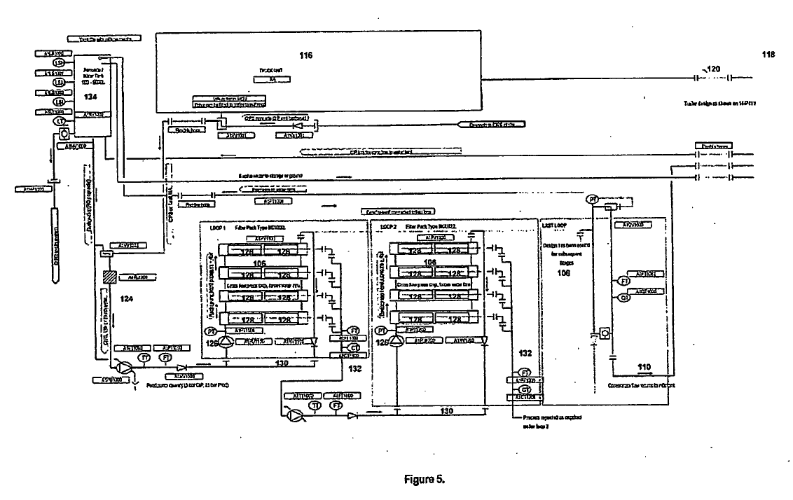

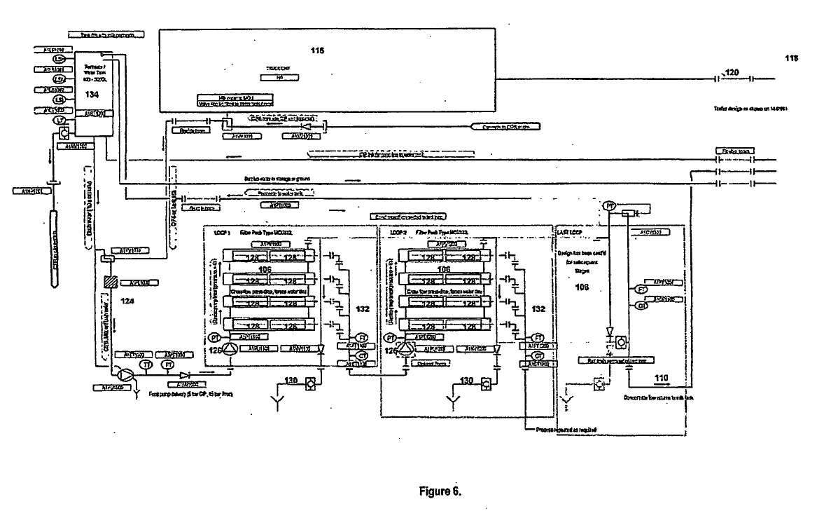

Four separate embodiments of the present invention are illustrated and described in this patent application and can be described as follows:
FIG. 3 is a Single loop, with or without circulating pump.
FIG. 4 is a multiple loop, continuous retentate concentration.
FIG. 5 is a multiple loop, continuous permeate concentration with permeate feed boost (known as 2 (or more) stage operation.
FIG. 6 is a multiple loop, continuous permeate concentration, array design (with or without boost pump).

The last loop on each drawing demonstrates the retentate take off connection detail to the last stage of each plant.

Water that is separated from the milk is either discarded to the road, or collected and returned to the farmers or effluent dumping station.

The Mobile Concentration System (MCS) is a machine utilizing Reverse Osmosis (RO) filtration technology to remove water/permeate from the milk being collected by the milk tanker. The main features of the systems are as follows:
The MCS is completely mobile. The system utilises on-board energy for its operation.
The MCS uses local operating power from the either the truck engine or mobile power pack (hydraulic and/or electric).
The MCS permits the milk to be concentrated while being transported.

### Energy Sources

The MMCS can be powered by any ‘mobile’ power source available and installed on the truck. This includes such examples as:
Hydraulically from the truck Power-Take-Off (PTO) unit (to hydraulic motors on the pumps).
Hydraulically from a diesel powered hydraulic power source located on the truck (to hydraulic motors on the pumps).
Electrically from a diesel powered Electric power source located on the truck (to electric motors on the pumps).

The MCS can contain a combination of pumping units to service the membrane vessel pack used. Differing vessel pack designs require differing module design (one pump or two), and pumping capacities (amount of membrane area connected). The limitations are essentially the power that can be delivered to the unit by the power system either carried by the truck or provided by the truck's own systems.

The larger the unit's capacity, the larger the pumps will be and more truck power and infrastructure they will require to operate.

Construction

The Mobile Concentrating System (MCS) can be constructed to Dairy Processing Industry standards, and units preferably are able to pass regulatory checking to ensure its ability to process food products.

### Materials

The food contact surfaces of the MCS can be made from stainless steel, though other materials may be used (examples are plastic & carbon based products). Permeate tanks are lightweight plastic moulded.

The pumps and valves are also preferably made of stainless steel construction and are of a Dairy Hygiene standard design commonly used in the food processing industry.

### Design

System relies on the pumping system to deliver the flow and pressure range required of the system. Pump ‘type’ selection could be utilised and could include examples as follows:
Centrifugal
Positive Displacement (lobe or progressive cavity).

### Pressure Vessels

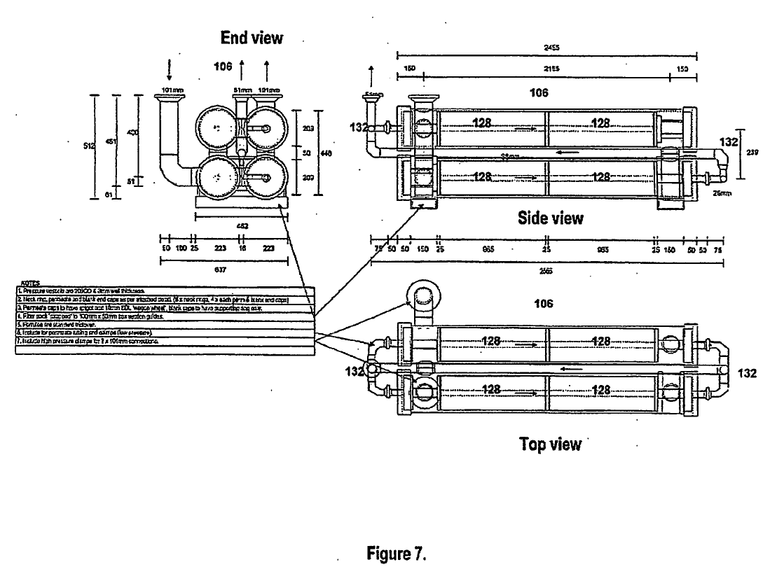

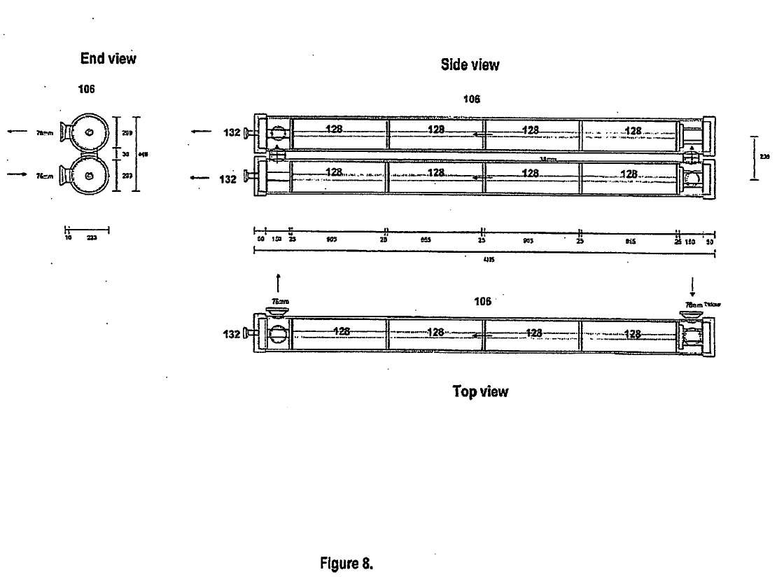

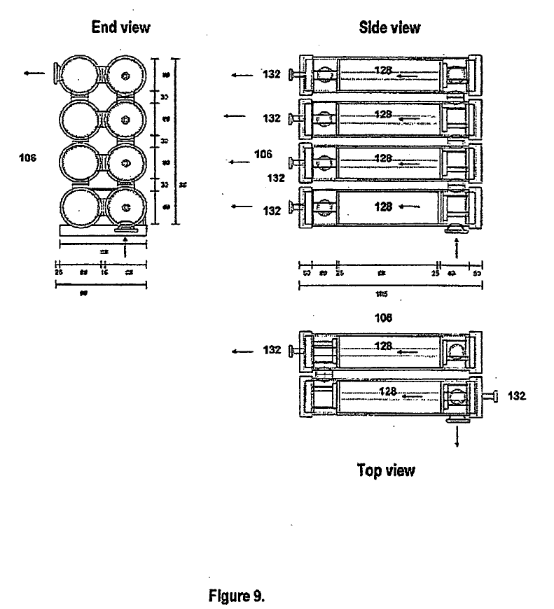

Pressure vessels are preferably constructed to withstand up to 70 bar pressure generated by the system. The pressure vessels are modular in design to allow for the construction of any vessel pack layout combination needed. Three different vessel packs are illustrated and described herein, and can be seen in FIG. 7, FIG. 8 and FIG. 9. Since the pressure vessels are modular, the number of pressure vessels can be easily increased, or decreased, to increase or decrease the capacity of the system as needed.

Pressure vessels may be sized to suit any diameter of filter membrane selected. In the illustrated embodiment, 200 mm (8 inch) diameter, cylindrically shaped pressure vessels are illustrated, though it is noted that other diameters and shapes within the spirit and scope of the present invention.

### Configurations

System designs allow for the selection of single or multistage plant designs. For instance, in one embodiment, five stages (for a continuous concentrating plant) are used. In multistage versions, the permeate/water from the previous stage is pumped to pressure and fed into the second stage etc.

Each stage added to the plant design requires a recirculation pump to be added. This results in increased costs and power required to operate the MCS.

FIGS. 3-6 show four preferred RO plant designs for the MCS.

### Installed to the Tanker

The system fits to a unique coupling mechanism bolted to the truck's frame rails (for standard design—front & aft) or tank gussets (for side mount design). The MCS is easily removable if required, and can be completely isolated from the tanker's normal in-loading, storage and out loading functions.

Hygienic flexible hoses connect the system to the milk tanker and permeate tank via the remote divert valves to receive and send milk.

The system is so constructed to handle the tough and rigorous travelling environment the MMCS is expected to encounter.

### Size

The size of the system is preferably sufficiently small in size, and in weight and power consumption for that matter, to allow the system to be mounted to a standard milk transport vehicle, such as a milk tanker truck, without any or minimal modification to the truck, and to permit the system to be powered by the truck's existing power generation equipment or by a small self-contained add on power source. Preferably the components of the system added to the standard milk transport vehicle occupy a volume that is less than 4 m³, or even less volume, such as less than 3, 2, or 1.5 m³. The small volume further permits the amount of milk carrying capacity of the vehicle to be maximized. Preferably the components of the system added to a standard milk transport vehicle weigh less than 1 ton (with the components filled with water and milk), and most preferably, even less, such as less than a ½ ton. Preferably the liquid storage capacity of the components added to the truck is less than 1,000 litres (i.e. the amount of liquid that the flush water tank, filter packs, and associated piping can hold; excluding the permeate storage tanks).

Operational Concept

Refer to FIG. 3, the operation of the MCS will now be described.

Products

The illustrated embodiment is ideally suited for processing raw cow's milk based on existing 27,000 L capacity tanker capacities, although it is noted the system may be used for other products and other quantities.

Performance

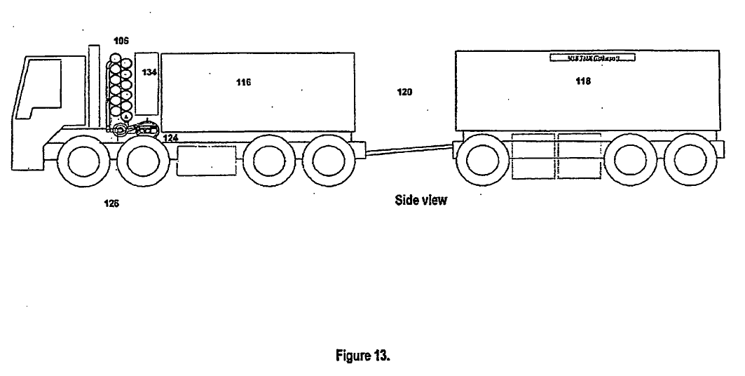

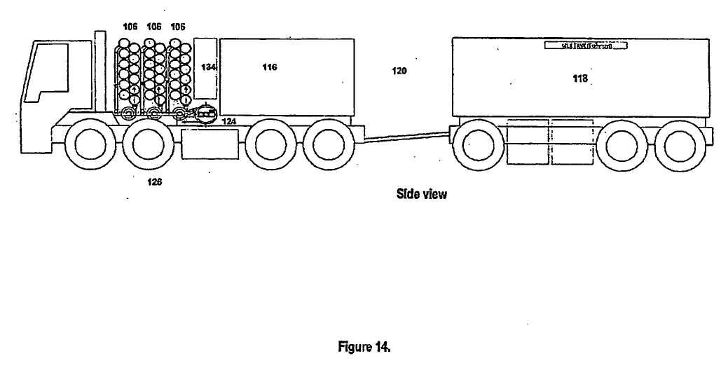

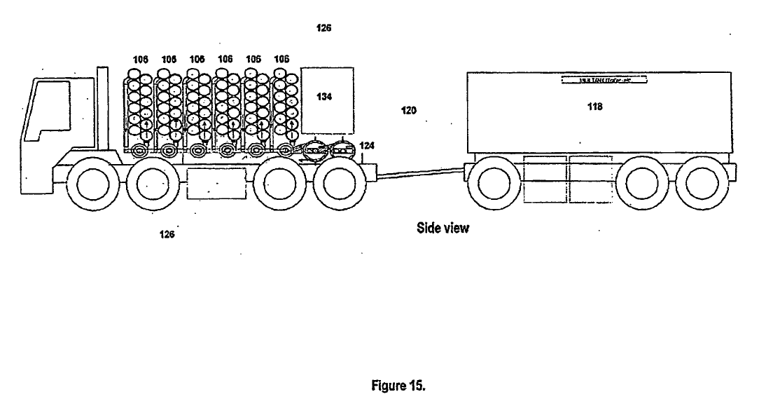

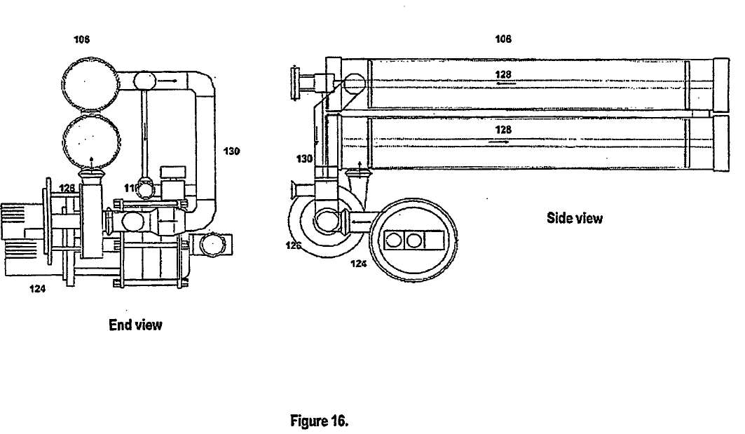

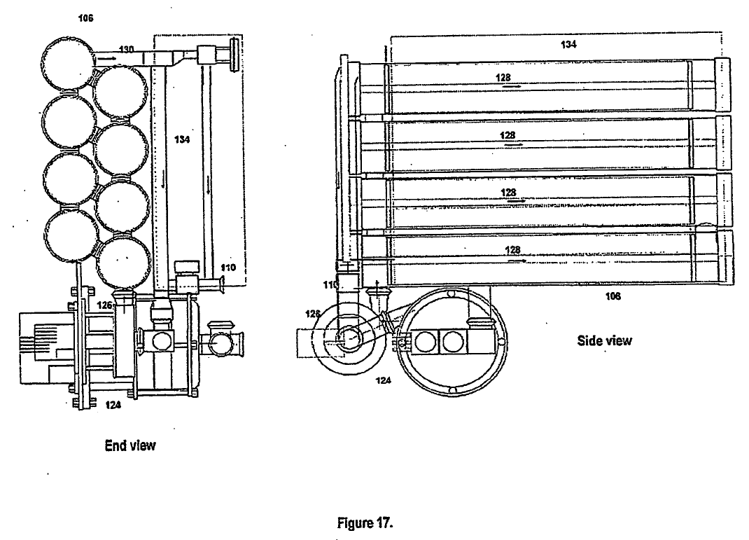

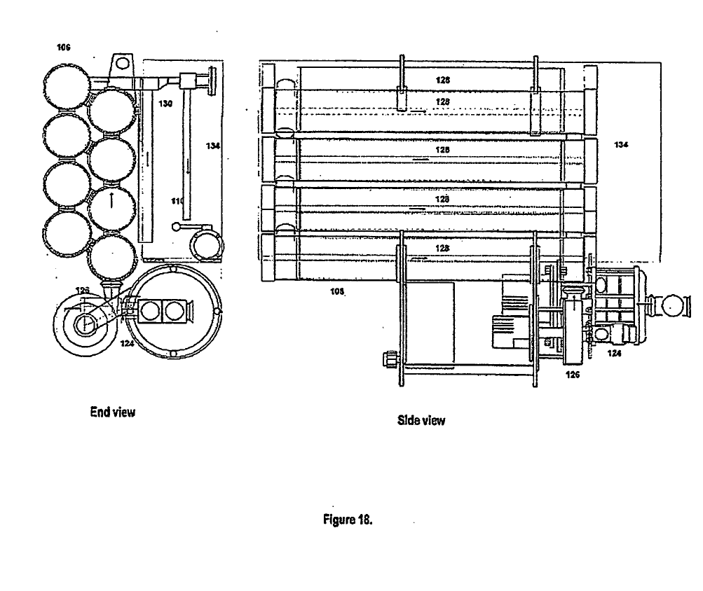

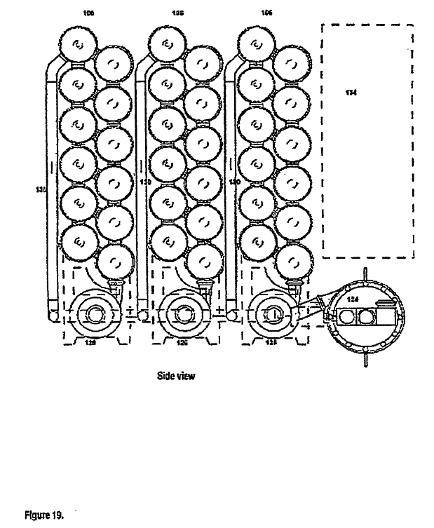

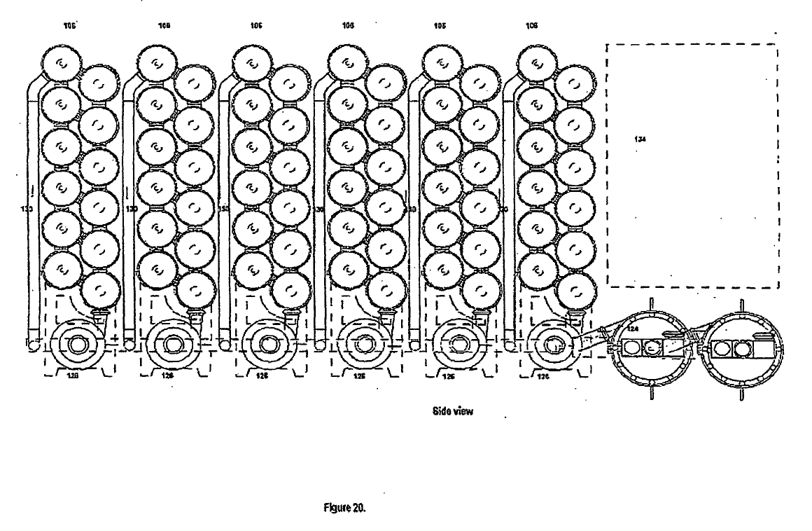

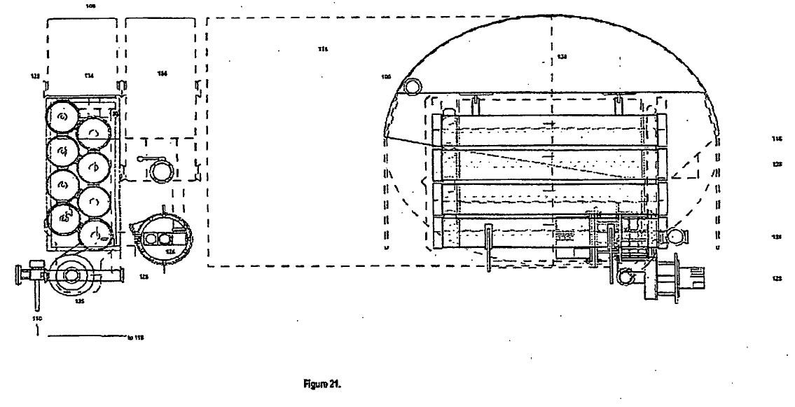

The MCS performance can be scaled up or down to meet the needs of the end user. The performance tables provided in FIG. 13 demonstrate the expected operating parameters this design can operate at through the duration of all operational cycles.

The plant's performance range and limits are as shown in the table 6.2

TABLE 6.2

| Location | Measuring | Min | Max | Scale |
|---|---|---|---|---|
| Filtered water tank | Holding | 0 | 50000 | L |
| | Volume | | | |
| | Temperature | 0 | 100 | deg C. |
| | Pressure | 0 | 20 | bar |
| Feed pump & Line | Temperature | 0 | 100 | deg C. |
| | Flow | 0 | 100 | m3/hr |
| | Pressure | 0 | 100 | bar |
| Pressure vessels | Temperature | 0 | 100 | deg C. |
| | Flow (ea) | 0 | 30 | m3/hr |
| | Pressure | 0 | 100 | bar |
| | Vessel | 100 | 1000 | mm |
| | diameter | | | |
| Permeate/water tubes | Temperature | 0 | 100 | Deg C. |
| | Flow | 0 | 40 | m3/hr |
| | Pressure | 0 | 40 | Bar |
| | Conductivity | 0 | 6000 | ms/cm |
| Concentrate discharge line | Temperature | 0 | 100 | Deg C |
| | Flow | 0 | 100 | m3/hr |
| | Pressure | 0 | 40 | Bar |

Preparation for Operation

The Mobile Concentration System (MCS) prior to operations requires the filter membranes to be installed. These are installed according to the filter pack design selected, with ATD's (Anti Telescoping Device) separating all membranes from each other, and the vessel end caps. The MCS is then rinsed to remove the glycerine compound the membranes are preserved with. Once membrane installations are completed and rinsed, the system is ready for CIP (Clean In Place).

Water Recirculation

This step is where the MCS operates prior to any active process being initiated (production, CIP, flushing etc). It is where the system finishes when either of the main processes is completed.

It is effectively a safe step where the system is in complete isolation of the tanker, and continues to recirculate on its own water. The system can be shut down entirely when not required. It is advised not to do this after product has been in the plant.

All divert valves are in the de-energised position. Water is drawn from the permeate/water tank A1BT1000 and diverted through valve A1VV1000 into the pre-filter A1FL1000. The high pressure pump A1PU1000 then delivers the water into the pressure vessel prior to the recirculation pump A1PU1100 (if recirc option used).

The recirculation pump A1PU1100 continues to recirculate the product at high velocity around the membrane vessel pack, with water permeating to the permeate tubes and retentate piped off via the retentate valve A1CV1000 and bypass valve A1VV1002. The bypass valve A1VV1002 remains de-energised during water circulation.

Water through the retentate stream passes through the closed divert valve A1VV1003 mounted on the truck or trailer tank, and back to the permeate/water tank.

Water through the permeate tubes is piped to the permeate/water tank through the tank spray ball. Permeate conductivity A1CT1100 is measured at this point and indicates:
If any membranes are leaking.
If concentration target has been met.

At this point, either way, the plant needs to be emptied (purged) and made ready for inspection/CIP.

The water level in the permeate/water tank stabilises and the system continues to recirculate until a process function is initiated.

Clean in Place (CIP)

The MCU unit can be cleaned in either of the following ways:
In circuit with the tanker CIP.
The tanker water supply must be within membrane limits, and specialised chemicals required in tanker CIP system.
Self contained internal cleaning system (needs site water)
Preferred for lighter product duties, utilises tanker exhaust system for heat, ‘tablet’ or measured liquid volume thrown into permeate/water tank to dissolve for chemicals (correct concentration).
Site connected CIP system.
A purpose built site CIP system (single or re-use) is connected to the MCS by hoses and provides and removes the cleaning fluids necessary for the cleaning of the units. Various cleaning regimes can be selected, and range from a simple rinse to a comprehensive multi stepped cleaning from (up to 5 cleaning cycles).

### Depending on the Cleaning Style Adopted, the Following Functions Occur:

Cleaning with the Tanker

The tanker CIPR hose is connected to the MCS permeate/water tank CIPR outlet port. This becomes the new tanker CIPR, and the tanker outlet port (where the CIPR hose was connected) has its manual valve closed (the MCS is connected just upstream of this valve).

With the tanker outlet butterfly valve closed, the CIPS divert valve for the MCS activates and takes cleaning solution as it exits the main tank. The CIP solution is circulated in the same fashion as ‘water recirculation’ with all fluids returning to the permeate/water tank. These fluids then exit the CIPR drainage port and back to the tanker CIP system.

### Cleaning Itself

The MCS goes into its internal water recirculation mode, and the heating system is initiated (via the truck exhaust). As the fluid circulates it reaches its set point cleaning temperature, and a ‘tablet’ is added to the permeate/water tank to dissolve and clean the plant.

After a timeout, the system is ready to be flushed, and site water is added to the CIPS connection hose, and the CIPR port on the permeate/water tank diverts to effluent.

Cleaning with a Site CIP System

The ‘Site CIP Unit’ (SCU) CIPS hose is connected to the MCS CIPS connection port. The SCU CIPR hose is connected to the permeate/water tank CIP outlet port.

The operator starts the site SCU system which begins to clean the MCS. The operator can select any of a number of cleaning regimes as described above.

### General

Cleaning parameters are maintained (temperature, ph and pressure limits) during the system cleaning operations by the site CIP systems (tanker or dedicated CIP system), or by the number of ‘tablets’ or chemical volume added for the isolated cleaning type.

A sanitising will occur prior to the departure of the tanker, and the system is either shut down, or operates in recirculation awaiting the next phase of operation to be selected.

There is installed a bypass valve A1VV1002 across the retentate control valve A1CV1000 that activates during plug flushing (product recovery), rinsing and CIP chemical circulation.

Production

### Recirculation

The MCS operates in the recirculating mode prior to milk being introduced to the tanker.

The tanker operator continues their milk pick up operations as they have done previously.

Either by operator selection, or automatically (again, depending on options up-taken) the system will commence processing milks

### Filling

When the required tank level has been achieved, the system CIPS valve A1VV1001 activates, diverting milk to the permeate/water divert valve A1VV1000 which is also activated. The milk then passes through the pre filter A1FL1000 and into the system feed pump.

The milk is then pumped at pressure into the feed line and in the case of:
a. Single pump design; directly through the vessel pack and directly to the retentate control valve A1CV1000.
b. Dual pump design; directly into the suction/inlet of the recirculating pump A1PU1000 and recirculated around the vessel pack, then to the retentate control valve A1CV1000.

The retentate control valve A1CV1000 will control the rate of retentate sent back to the truck tank, so a fixed operating pressure can set within the vessel manifold (between 0 and 70 bar) at A1PT1000.

The retentate stream after control valve A1CV1000 is fed to the retentate divert valve A1VV1003 (mounted back on the trucks tank, or alternatively the trailer tank) and diverted back into the main body of milk.

With the operating pressure growing as the milk fully concentrates the vessel pack, more water is permeated through the membrane surface, and this is directed out through the permeate tubes, through the permeate/water tank spray ball, and into the permeate/water tank A1BT1000. The tank continues to fill until overflowing, then simply overflows to the road or holding tank(s) A1BT1001-4.

The water generated at the start of production is used for the flushing of the plant when shut down is required (when the target total solids are achieved, or shut down initiated). The volume required can range from minimal volumes for the smaller designs to in excess of 5000 L.

### Production

The MCS will continue to process the milk as the truck continues its collection route. System designs determine the size of the plant, which determines the rate of processing which determines how fast the truck can concentrate its milk.

Systems are typically sized to complete the required volume reduction within 6 to 8 hours, but can be tailored to suit specific requirements.

The MCS uses any of a number of process signals from the instrumentation to determine when maximum concentration levels are reached. The signals used depend on the level of instrumentation adopted for the MCS. Signals include:

1. Permeate Conductivity measurement (incl in all models): PCT>SP (set point)
2. Permeate flow measurement: PFT<SP
3. Feed Pressure measurement: PPT>SP
4. Feed Total Solids measurement (refractometer etc): QFT<SP

When the production process is completed (either by total solids achieved, or driver intervention), the system then steps into a purge phase which empties the contents of the MCS into the truck or trailer tank.

### Purging

The system automatically stops taking milk from the truck tank by de activating the CIPS/feed divert valve A1VV1000, and the water/product divert valve A1VV1000 prior to the feed pump A1PU1000.

The re-circulation pump A1PU1100 stops (if installed), and the feed pump A1PU1000 is allowed to gently blow the contents of the MCS through the recirculation pump A1PU1000 (not running; this allows the loop non return valve A1NV1100 to close and the flushing to function correctly), through the membranes, back to the retentate bypass valve A1VV1002 which has been activated.

This continues until a low level set point has been reached in the permeate/water tank and the system returns to the water re-circulation phase until production is restarted, or a clean is initiated.

Parameters

The MCS utilises RO (Reverse Osmosis) technology to separate the water from the milk and as such the equipment operates at high pressure and product/CIP fluid velocities.

Operational parameter limits for the MCS as follows:

TABLE 8.1

| Location | Measuring | Min | Max | Scale |
|---|---|---|---|---|
| Filtered water tank | Holding | 0 | 50000 | L |
| | Volume | | | |
| | Temperature | 0 | 100 | deg C. |
| | Pressure | 0 | 10 | bar |
| Feed pump & Line | Temperature | 0 | 100 | deg C. |
| | Flow | 0 | 100 | m3/hr |
| | Pressure | 0 | 100 | bar |
| Pressure vessels | Temperature | 0 | 100 | deg C. |
| | Flow (ea) | 0 | 50 | m3/hr |
| | Pressure | 0 | 100 | bar |
| | Vessel | 100 | 1000 | mm |
| | diameter | | | |
| Permeate/water tubes | Temperature | 0 | 100 | Deg C |
| | Flow | 0 | 40 | m3/hr |
| | Pressure | 0 | 20 | bar |
| | Conductivity | 0 | 6000 | ms/cm |
| Concentrate discharge line | Temperature | 0 | 100 | deg C. |
| | Flow | 0 | 100 | m3/hr |
| | Pressure | 0 | 40 | bar |

Each MCS operating parameters will differ from one to the next depending on the vessel pack design and product being separated. The actual operating parameters are established at that point, but generally fall within the limits as described in table 8.1.

Electrical Services

Electrical systems required on the MCS are limited to the LV power to operate all the control devices on the hydraulically powered systems.

If the diesel to electric generator option is utilised, the electrical control is included to operate the electrically driven pump units. This includes electrical panels, motor starters and MV power distribution through out the module.

As the level of instrumentation and automation increases, the LV power required of the control systems increases, and the power system design adjusts to allow for this increase.

Motor Control Centre

The MCU will have a power distribution and management system for the MV power being supplied by the diesel electrical generator option.

For the hydraulically powered systems, power for the automation systems is delivered directly from the truck power network (normally 12 or 24 VDC or AC).

Variable Speed Drives (VSD)

The MMCS for the electrical generator option will have an electrical VSD or frequency converter installed to operate the System feed pump.

Speed control requirements will be via hard wired 4-20 mA signalling or for a proprietary communications protocol; drive control (eg, Devicenet, Profibus) as requested by the end user.

Power Cabling

Power cabling will be included for the electrical generator option selection and will be as follows:

All 400 volt cabling will be segregated from control and instrument cables. Power and control cables will not be installed within the same conduit or trunking system.

The power cabling utilised will be 3C&NS/PVC of the appropriate sizing according to the requirements of the load connected, length of run and installation environment. 400 V field isolators are also included for all motors complete with feed backs to the nearest field panel. Power cabling systems will be tailored as required to meet the requirements of the country the systems will be operating in.

Control and Instrument Cabling

Supply and installation of all new IO control and instrument cabling has been allowed for as required for any level of instrumentation selected.

Any device transmitters as required such as flow transmitters, conductivity transmitters, RTD three wire transmitters and safety barriers will be installed in the panel fitted to the MCS.

RTD cable will be one continuous three wire (triple) screened cable direct from the probe head to the isolated transmitter.

The following types of cable can be installed to devices mounted in the field:

| | |
|---|---|
| 6 core pvc flex | Product and Services valves |
| 2 or 3 core pvc flex | Level switches, proximities, solenoids, |
| | motor isolators, pushbuttons etc. |
| B5102 ES | 2-wire analogue instruments |
| B5103 ES | RTD Elements |
| B50xx ESCS | Flow and conductivity transmitters etc. |

Instrument power supply and analogue fuses will be located in the field panel.

All instrument cables will be segregated from the power cables by installation in the control & trunking cable support system.

Cable Support System

The MCS will include 304 stainless steel conduit to protect all cabling installed.

Control Panels

The MCS control panel can vary in size according to the type of MCS configured. This can be quite small if the basic instrumentation package with hydraulic power is selected, or quite large should a high level of automation is adopted along with the electric generation option. The panel will house the host PLC rack, local IO cards where required, system power supplies and HMI PC's. A compartment will house the hydraulic control equipment, and the compressed air control equipment.

The control panels can consist of stainless steel, IP65 rated panels, complete with sloping roof manufactured to hygiene standards.

Automation and Control Systems

Overview

The MCS may be configured with varying levels of automation and control. These options are established at the design phase.

A full level of instrumentation (as shown on FIG. 3 (144P001A)) can be connected to a PLC (Programmable Logic Controller) and in turn an HMI (Human Machine Interface). The MCU control package includes well known hardware and software programs, which for the sake of brevity, will not be described in detail herein.

The MCS system can include for a communications link to external systems by any available means, examples include wireless, RF, GPS.

A more simplified design cuts down on the minimum transmitters required to temperature and conductivity. All other metering can be replaced with indicators or nothing. This is at the discretion of the user/customer.

PLC System

Any now known or to be developed PLC may be used with the present invention.

Operator Interface

Any now known or to be developed operator interface may be used with the present invention.

The operator interface provides one or more of the following types of information:
Menu pages
Process and CIP overview pages
Fault overview pages
Process and CIP selection pages.
Process and CIP graphics pages
Trend pages
Manual operate popups

The system provides process and CIP status/fault text and graphics messaging.

The PLC may include code to support comprehensive text messaging throughout each individual process and CIP selection. Process and CIP overview pages may be implemented using queuing. Code is preferably structured and fully documented for ease of reading and maintenance.

Functional Descriptions

Simulation can be used for verifying correct operation. Simulation of the process and CIP logic may utilise the operator interface and completed PLC program. Additional PLC code may be developed to assist in simulation including:
Drive and valve feedbacks will energise and mimic the output state with a real time delay to simulate valve response time etc.
All PLC digital inputs will be forced on or off to simulate process conditions and/or fault conditions.
PLC analogue inputs will be enabled to allow simulation and setting through the operator interface. Inputs for controllers will be able to track the controller controlled variable if necessary.
Analogue switch points and controller set points and output values will be able to be modified through the operator interface during simulation.

Reporting

The system may be configured to allow the generation of production reports at the end of each operating cycle.

Instrumentation

The level of instrumentation adopted on the MCS may vary greatly depending upon a user's needs. The following list describes the many instruments that can be utilised on the MCS (but not limited to).

A full level of transmitters can be described as follows:

### Unit Feed:

a. Temperature Transmitter (feed flow)
b. Pressure Transmitter (feed line pressure)
c. Flow Transmitter (feed flow)

### Vessel Pack:

a. Temperature Transmitter (membrane temperature)
b. Pressure Transmitter (boost pressure)
c. Flow Transmitter (permeate flow rate)

### Retentate Stream:

a. Temperature Transmitter (Retentate line temperature)
b. Pressure Transmitter (retentate line pressure)
c. Flow Transmitter (retentate flow)
d. Brix or total solids metering (retentate brix or total solids).

### Permeate/Water Tank:

a. Level switches/Transmitters. (permeate/water tank operating levels)
b. Conductivity Transmitters (water conductivity).
c. Turbidity Metering (water solids).

A more simplified design cuts down on the minimum transmitters required to temperature and conductivity. All other metering can be replaced with indicators or nothing. The amount of monitoring is at the discretion of the user.

Other methods for which the MCS can be used are now discussed with respect to FIG. 22.

Larger scale ‘multi stage’ plants ie labelled as Type 2 in FIG. 22, that concentrate the milk in a single plant pass, and have more than 1 filter stage (multistage plants require less membrane surface area than single stage). This embodiment can be used as for method 1. or can be continuously driven around the collection route, concentrating the milk into it's trailer unit (this can continue for many hours, typically 20 hours). Bulk haul tankers from the processing plant meet the mobile concentrating unit, transfer the concentrate, and deliver the milk to the processing plant. This system comprises (as a minimum) one feed section module 124, and two or more filter modules 106, this design is intended to travel the collection route, picking up and concentrating milk continuously. The system has a farm milk holding tank 116, MCS, permeate holding tank 134 and produces full strength concentrate continuously which is stored in the trailer unit 118. Bulk haul tankers from the factory collect the concentrate from the membrane truck and transfers it to the factory.

Even larger scale ‘multi stage’ type plants capable of greater volumes than the previous ‘larger scale’, is labelled as Type 3 in FIG. 22. This embodiment would typically travel to the centre of the catchment area, and vehicles/milk tankers collect the milk, deliver it to the mobile concentration system for processing, and bulk haul tankers ferrying the concentrate to a processing plant. The system 100 comprises (as a minimum) two or more feed section modules 124, and two or more filter modules 106, this design is basically all RO (i.e. membrane) plant. This design is intended to travel to a stationary area along the collection route, other trucks collect the milk and deliver it to the stationary truck membrane plant or mobile-milk concentration system 100 where it is processed and stored in trailer units 118 brought to the site. System 100 has a small feed tank 116, pump system 104, water or permeate holding tank 134 and produces full strength concentrate continuously which is stored in the trailer units 118 brought to the site. Bulk haul tankers from the factory collect the concentrate from the storage trailers and transfer it to the factory. The membrane truck will still return to the factory at periodic intervals for cleaning.

Power can formed as a separate component to the MCS or it may be combined or it may be mains connectable or be self powered as in solar power or batter. The term ‘vehicle’ can loosely be defined as any means of conveyance that allows the MCS to be moved or be portable. For example a ‘vehicle’ can be a: truck, trailer, train, wagon or a plane.

In summary the following issues and problems in the milk processing industry are discussed with respect to the present invention:
(a) Difficulty in cleaning: Membrane plants have always been difficult to clean. While the plant design presented can be cleaned in place on the truck, it is likely that the system will require assistance from a land based cleaning plant located at the factory. This system will provide the chemical solutions, and rinsing water at significantly higher flow and pressure rates than would normally be achievable without the cleaning system to ensure the system can be cleaned.
(b) Operating risks: The plant membranes need to be protected against damage due to pressure, temperature and chemical exposure limits being exceeded, and this is typically done with a comprehensive range of instrumentation. The plants mechanical design is such that membrane pressures, temperatures and chemical exposures cannot be exceeded. Pumps are mechanically specified to ensure pressure limits are not exceeded, and the plant based cleaning system has the instrumentation necessary to ensure temperature and chemical strength limits are not exceeded.
(c) High operating power requirements: Advances in modern pump designs have reduced the need for the traditional high power needs for the membrane plant. We have established what is required in terms of plant capacity (collection rate), and optimised the plant design to suit. This has in turn ensured the correct pumps are specified for the duties required, and has resulted in a plant that will draw in the region of 60 kw of truck power (for example).
(d) Technically demanding: Factory based membrane plants have a wide range of instrumentation fitted and automated computer control systems which allow the plant to operate in many ways. Surprisingly the present invention, while able to carry this full range of instrumentation & control, has been designed to operate with a minimum level of instrumentation and automation & control which allows for a basic and simple method of operation. The present invention plant can run with a conductivity meter only monitoring permeate solids (determining solids level of finished product) and the concentrate flow from the plant can be controlled by maintaining a constant system pressure only (as opposed flow/ratio and total solids control). This means we can considerably reduce the level of instrumentation and control equipment necessary to operate the plant (considerable weight is also saved).
(e) Physically large plants: Membrane plants are traditionally large and heavy. Standard membrane plant construction methods today make them un-workable on a truck as too much milk carrying capacity is sacrificed by the shear weight of the plant. The present invention covers a method of detailed plant construction which optimises the design and specifications of all plant components which reduces the all up weight of the system and makes it viable for use on a truck. The considerable weight of standard membrane plants is the most likely reason the concept of membrane filtering on a mobile vehicle could have been discounted in the past.

### Advantages

A mobile concentration system (MCS) formed in accordance with the present invention may exhibit one or more of the following advantages:
a) Able to concentrate milk while the milk transport vehicle is stationary and/or uploading or unloading of milk, or underway;
b) Able to store and carry raw product for processing;
c) Able to be self contained, such that external power is not required;
d) Able to run off the regular power system of the milk transport vehicle;
e) Small in volume;
f) Lightweight;
g) Low power consumption;
h) Reliable;
i) Easy to operate;
j) Significantly increases the amount of raw product that can be picked up; and
k) Can be fitted onto a regular milk transport vehicle with minimal or no significant modifications to the milk transport vehicle.
l) All milk collection, concentration, bulk transport and storage systems return to the factory daily for cleaning and servicing.
m) Several different ‘modes’ of operation, designs and capacities available.
n) Mobile system is suited to any liquid food that can be membrane filtered such as for example wine, juice or milk.

### Variations

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described. The application of this invention as described in this patent document can also be applied to the de-salination process of sea water and river water (fit for drinking). Such a machine would travel to the water source (coast or river), extract the water and produce fresh drinking water in the vehicle tanks. When full, the water is then transported in the vehicle to where it is needed. System is fully mobile, and driven by on-board power.

Although specific values, a few examples being pressures, flow rates, temperatures, sizes, etc., are mentioned within this detailed description, it is noted that these particular values are illustrative in nature only and not limiting.

1. A mobile concentration system (MCS) for milk comprising:
(a) a vehicle having at least one holding tank for receiving and holding milk; and
(b) a concentration system mounted to the vehicle and coupled in fluid communication with the holding tank, the concentration system adapted to remove milk from the holding tank and process the milk while the vehicle is stationary and/or uploading or unloading of milk, or underway, the concentration system including a reverse osmosis filtration system adapted receive the milk from the holding tank and process the milk to generate a stream of substantially water and a product stream of concentrated milk, leading to another holding tank or the same holding tank.
(c) the concentration system including:
(d) Feed section comprising product/water/CIP (clean in place) valving systems, high pressure pumping equipment operating to receive and pressurize the milk through-out the system.
(e) Concentration level control system comprising a control valve regulating the concentrate flow to achieve a fixed system operating pressure to control the system.

2. The mobile concentration system as claimed in claim 1 wherein the system includes conductivity monitoring of the water to determine when target milk solids are achieved.

3. The mobile concentration system as claimed in claim 2 wherein the concentration system includes a filter module comprising membranes, pressure vessels, recirculation pumping equipment and water collection tank operating where milk is pumped through the pressure vessels and the filter membranes by the recirculating pump, creating a cross flow across the filter membrane with wastewater going to the water collection tank, and the concentrated milk is pumped via a concentrate line to the holding tank.

4. The mobile concentration system as claimed in claim 3 wherein water or permeate can be stored in storage systems or can be discharged.

5. The mobile concentrations system as claimed in claim 4 wherein the holding tank for the milk concentrate is a separate movable storage tank.

6. A method of collecting and concentrating milk from the mobile concentration system as described in claim 1, the method comprising:
(a) utilizing the feed section and depositing milk into a holding tank of a vehicle;
(b) drawing milk from the holding tank while the vehicle is stationary and/or uploading or unloading of milk, or underway and directing the milk to the concentration system carried by the vehicle;
(c) operating the concentration system while the vehicle is stationary and/or uploading or unloading of milk, or underway to remove water from the milk by reverse osmosis filtration system in combination with the concentration level control system whereby the MCS is operating under pressure to separately produce concentrated milk and water; and
(d) delivering the concentrated milk to a processing factory, or transferring the concentrated milk to ‘bulk haul’ vehicles who deliver the concentrated milk to a milk concentration processing plant.

7. A method of operating the mobile concentration system (MCS) to form milk concentrate and waste water as previously claimed in claim 1, in a batch style operation and the MCS in this claim includes a single module type A and single module type B coupled to at least one vehicle holding tank and simultaneously extracts water, and deposits the milk concentrate in the same holding tank or the other holding tank so that milk concentrate is delivered to a milk concentration processing factory whereby the concentrate would not be transferred to a factory bulk haul vehicle.

8. A method of operating the mobile concentration system (MCS) as previously claimed in claim 1 to form milk concentrate and waste water, in a single pass operation, the MCS in this claim comprises a vehicle, at least one module type A, and two or more module type B, whereby this system design is intended to travel a milk collection route, picking up and concentrating milk continuously, the system has a farm milk holding tank, MCS, water/permeate holding tank and produces full strength concentrate continuously which is stored in the vehicle trailer unit so that bulk haul vehicles from a factory can collect the milk concentrate from the system vehicle and transfers it to the factory.

9. A method of operating the mobile concentration system (MCS) as previously claimed in claim 1 to produce milk concentrate and waste water, in a single pass operation, the MCS in this claim comprises at least one vehicle, two or more module type A, and two or more module type B, whereby this MCS is intended to travel to a stationary area along a milk collection route, other vehicles collect the milk and deliver it to a stationary vehicle where it is processed and stored in vehicle trailer units brought to the site so that the MCS has a small feed tank, MCS, permeate holding tank and produces full strength concentrate continuously which is stored in the trailer units brought to the site, bulk haul vehicles from a processing factory collect the milk concentrate from the vehicle storage trailers and transfer it to the factory and the mobile milk concentration system will still return to the factory at periodic intervals for cleaning.

10.-14. (canceled)
